(19) United States
(12) Patent Application Publication
(10) Pub. No.: US 2004/0123490 A1
(43) Pub. Date: Jul. 1, 2004

(54) Fabric article treating method and device comprising a heating means

(75) Inventors: Eugene Joseph Pancheri, Cincinnati, OH (US); Janine Morgens Strang, Deer Park, OH (US); Andrew Julian Wnuk, Wyoming, OH (US); Brian Joseph Roselle, Fairfield, OH (US); Christopher Lawrence Smith, Liberty Township, OH (US); Dean Larry DuVal, Lebanon, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/697,736

(22) Filed: Oct. 29, 2003

Related U.S. Application Data
(63) Continuation-in-part of application No. 10/418,595, filed on Apr. 17, 2003.
(60) Provisional application No. 60/374,601, filed on Apr. 22, 2002.
(60) Provisional application No. 60/426,438, filed on Nov. 14, 2002.

(51) Int. Cl. F26B 11/02

(52) U.S. Cl. 34/597

(57) ABSTRACT

A fabric article treating device for use with a fabric article drying appliance. The fabric article treating device dispenses a benefit composition into a chamber so as to provide benefits to fabric articles contained within the fabric article drying appliance. The treating device includes a means of heating the benefit composition.

### CROSS REFERENCE TO RELATED APPLICATIONS

This application is a continuation-in-part of U.S. application Ser. No. 10/418,595 filed Apr. 17, 2003; which claims the benefit of U.S. Provisional Application Serial No. 60/374,601, filed Apr. 22, 2002; and U.S. Provisional Application Serial No. 60/426,438, filed Nov. 14, 2002.

### FIELD OF THE INVENTION

The present invention relates to a removably attached treating device for use with a fabric article drying appliance (a non-limiting example of which includes a clothes dryer). The treating device may be a stand-alone discrete device. The treating device dispenses a benefit composition through a nozzle that directs the benefit composition into a chamber (a non-limiting example of which includes the drum of a clothes dryer) so as to provide benefits to fabric articles contained within the fabric article drying appliance. The treating device comprises 1) one or more sources of a benefit composition, 2) a dispensing means, and 3) one or more means for heating the benefit composition. The treating device may also include a power source.

### BACKGROUND OF THE INVENTION

A variety of methods and/or devices for removing creases in fabrics are well known in the art, particularly those that employ the usage of thermal, mechanical, or chemical energy. Wrinkle removal becomes more effective by employing more than one type of energy. For example, while some wrinkle removal may be achieved with chemical energy via fiber lubrication, a more effective means is to additionally add mechanical energy to the fabric by subsequently tugging the item to the desired configuration. In an alternate method, the chemical energy is supplemented by heating the composition. While the aforementioned methods have been found to be somewhat effective for wrinkle removal, they often lead to less than completely satisfactory results.

Most effective wrinkle removal means employ all three energy types: thermal, mechanical, and chemical energy. While not wishing to be bound by theory, it is believed that while the chemistry provides the necessary lubrication for wrinkle removal, the addition of thermal and mechanical energy provide the additional energy needed to break the hydrogen bonds that hold creases in place. Conventional appliances such as a domestic iron have been found to be highly effective in wrinkle removal by providing all three energy types via pressure, water, and heat. Furthermore, if the chemistry is heated, e.g. steam, it has been found to be even more effective. However, regardless of the satisfactory results, ironing is often a labor-intensive process involving substantial setup and the treatment of garments on a piece by piece basis.

Attempts have been made to reduce the amount of labor involved in providing the three energy types for optimum wrinkle removal, involving spraying devices integrated in a clothes drying appliance. U.S. Pat. No. 2,846,776 purports to disclose a dispenser integrated into a clothes dryer for adding a liquid to clothing following the drying operation. U.S. Pat. No. 4,207,683 purports to disclose integrating a spray nozzle, control valve, and water line into a clothes dryer for spraying water on garments. A common drawback of these integrated dispensers is the expense and complexity they add to the drying appliance. Furthermore, as these devices are integrated into the dryer appliance, they provide little flexibility to the user. For instance, if an integrated device such as those described above malfunctions, it requires repairing the drying appliance. This can result in significant inconvenience and costly repairs to the user. Furthermore, the drying appliance cannot be operated during the period in which the repair is being made.

Thus it has been a long felt need to provide thermal, mechanical, and chemical energy for optimum wrinkle removal in a convenient and cost-effective manner. The treating device of the present invention is capable of being removably attached from the drying appliance. The treating device of the present invention may be a discrete stand-alone device. The treating device provides convenient wrinkle removal by delivering a heated benefit composition into the fabric article drying appliance so as to provide benefits to fabric articles contained within the fabric article drying appliance. Furthermore, the treating device of the present invention provides additional convenience to a user by eliminating the complexities, expense, and inconvenience associated with devices integrated into drying appliances.

### SUMMARY OF THE INVENTION

The present invention relates to a removably attached treating device for use with a fabric article drying appliance. The treating device dispenses a benefit composition through a nozzle that directs the benefit composition into a chamber so as to provide benefits to fabric articles contained within the fabric article drying appliance. The treating device comprises 1) one or more sources of a benefit composition, 2) a dispensing means, and 3) one or more means for heating the benefit composition. The treating device may also include a power source. The treating device may be a stand-alone discrete device.

The present invention also relates to a system for treating fabrics, said system for treating fabrics comprising:

a) a fabric article drying appliance; and

b) a fabric article treating device which is removably attachable to the fabric article drying appliance. The treating device comprises at least one means for heating a benefit composition and includes a dispensing apparatus for dispensing the benefit composition.

The present invention further relates to a method for treating fabrics. The method comprises

a) providing a fabric article treating device wherein the fabric article treating device comprises:

i) at least one source of a benefit composition;

ii) at least one means for heating a benefit composition; and

iii) a dispensing means for dispensing the benefit composition into a fabric article drying appliance.

b) providing a fabric article drying appliance;

c) adding fabric to be treated to the fabric article drying appliance;

d) removably attaching the fabric article treating device to the fabric article drying appliance;

e) heating a benefit composition; and

f) dispensing a heated benefit composition into the fabric article drying appliance.

### BRIEF DESCRIPTION OF THE DRAWINGS

FIG. 1 is a front view of an embodiment of a fabric article treating device made in accordance with the present invention.

FIG. 2 is a cross-sectional side view taken along line 2-2 of the fabric article treating device of FIG. 1.

FIG. 3 is a cross-sectional side view of an alternate embodiment of the fabric article treating device taken along line 2-2 of FIG. 1.

FIG. 4 is a cross-sectional side view of an alternate embodiment of the fabric article treating device taken along line 2-2 of FIG. 1.

FIG. 5 is a cross-sectional side view of an alternate embodiment of the fabric article treating device taken along line 2-2 of FIG. 1.

FIG. 6 depicts an embodiment of a system for treating fabrics in accordance with the present invention.

FIG. 7 illustrates an exploded view of a fabric article treating device according to an alternate embodiment of the present invention.

FIG. 8 is an exploded view of a fabric article treating device according to yet another embodiment of the present invention.

FIG. 9 is a perspective view of another embodiment of a fabric article treating device made in accordance with the present invention.

FIG. 10 is a perspective view from the opposite angle of the fabric article treating device of FIG. 9.

FIG. 11 is an elevational view from one side in partial cross-section of the fabric article treating device of FIG. 9 taken along line 3-3 of FIG. 9.

FIG. 12 is an elevational view from one side in partial cross-section of the interior housing portion of the fabric article treating device of FIG. 9 taken along line 4-4 of FIG. 9.

FIG. 13 is a schematic illustrating a thermoelectric module which may be used in accordance with the present invention.

FIG. 14 is an exploded view of another embodiment of the fabric article treating device of the present invention.

### DETAILED DESCRIPTION OF THE INVENTION

The phrase “fabric article treating system” as used herein means a fabric article drying appliance, a non-limiting example of which includes a conventional clothes dryer and/or modifications thereof. The fabric article treating system also comprises a fabric article treating device which may be used to deliver a benefit composition. The fabric article treating device is removably associated with the fabric article drying appliance, and may include non-limiting embodiments such as: a discrete device associated with the fabric article drying appliance by conventional methods such as Velcro®, magnets, straps, and the like; or it may be a device incorporated in a readily removable fabric article drying appliance closure structure which is substantially or wholly independent of the fabric article drying appliance controls.

“Fabric article” as used herein means any article that is customarily cleaned in a conventional laundry process or in a dry cleaning process. The term encompasses articles of fabric including, but not limited to: clothing, linen and draperies, clothing accessories, leather, floor coverings, and the like. The term also encompasses other items made in whole or in part of fabric, non-limiting examples which include tote bags, furniture covers, tarpaulins, shoes, and the like.

As used herein, the term “benefit composition” refers to a composition used to deliver a benefit to a fabric article. Non-limiting examples of materials and mixtures thereof which can comprise the benefit composition include: water, softening agents, crispening agents, perfume, water/stain repellents, refreshing agents, antistatic agents, antimicrobial agents, durable press agents, wrinkle resistant agents, odor resistance agents, abrasion resistance agents, solvents, and combinations thereof.

“Conduit” as used herein means a channel or pathway through which a benefit composition is conveyed. Non-limiting examples of conduits include: tubing, piping, channels, and the like which are capable of conveying a composition from point to point within the fabric article treating device. For instance, the conduit may convey the benefit composition from the dispensing means to a point of discharge, such as a nozzle.

The phrase “within the thermal path” as used herein means any location between a source of heat and one or more components of the device associated with the benefit composition and/or the benefit composition itself, including direct and/or indirect contact with sad one or more components. Non-limiting examples of sources of heat include: a fabric article drying appliance, an exothermic reaction, a heating coil, thermoelectric means, and the like.

The phrase “thermally conductive material” as used herein is used to describe any material that has a thermal conductivity, or k value, of about 5 W/m*° C. or greater at 25° C. The thermal conductivity of the material may be determined by a guarded hot plate method as described in ASTM method C 177-97 entitled “Standard Test Method for Steady-State Heat Flux Measurements and Thermal Transmission Properties by Means of the Guarded-Hot Plate Apparatus” or other suitable method known to those of ordinary skill in the art.

As used herein the terms “dryer” or “drying apparatus” or “fabric article drying appliance” include devices that may or may not perform a true drying function, but may involve treating fabric without attempting to literally dry the fabric itself. As noted above, the terms “dryer” or “drying apparatus” or “fabric article drying appliance” may include a “dry cleaning” process or apparatus, which may or may not literally involve a step of drying.

In addition, it should be noted that some drying appliances include a drying chamber (or “drum”) that does not literally move or rotate while the drying appliance is operating in a drying cycle. Some such drying appliances use moving air that passes through the drying chamber, and the chamber does not move while the drying cycle occurs. Such an example drying appliance has a door or other type of access cover that allows a person to insert the clothing to be dried into the chamber. In many cases, the person “hangs” the clothing on some type of upper rod within the drying chamber. Once that has been done, the door (or access cover) is closed, and the drying appliance can begin its drying function. A spraying cycle can take place within such a unit, however, care should be taken to ensure that the benefit composition becomes well dispersed within the drying chamber, so that certain fabric items do not receive a very large concentration of the benefit composition while other fabric items receive very little (or none) of the benefit composition.

The term “door,” as used herein, represents a movable closure structure that allows a person to access an interior volume of the drying appliance, and can be of virtually any physical form that will enable such access. The door “closure structure” could be a lid on the upper surface of the dryer appliance, or a hatch of some sort, or the like.

Fabric Article Treating Device

The present invention relates to a fabric article treating device capable of providing a heated benefit composition. The treating device may be a discrete stand-alone device. The device may be removably attached from the drying appliance. The treating device may be controlled substantially or wholly independently of the fabric article drying appliance controls.

Non-limiting examples of removable attachment include conventional methods such as Velcro®, magnets, straps, and the like. Alternatively, the treating device may be incorporated in a readily removable fabric article drying appliance closure structure (a non-limiting example of which is a dryer door) which is independent of the drying appliance controls.

Benefit Composition Heating Means

The fabric article treating device comprises one or more heating means placed within the thermal path between the fabric article drying appliance and one or more components of the fabric article treating device and/or the benefit composition itself. As used herein, the phrase “heating means” may comprise thermally conductive materials, heating coils, exothermic reactions, thermoelectric heating, resistive heating, and combinations thereof, whereby the heating means provides heat to a benefit composition prior to contacting a fabric article and/or prior to contacting the interior of a fabric article drying appliance.

The heating means is in thermal association with the benefit composition, prior to the contact of the benefit composition with the interior surface of the fabric article drying appliance and/or a fabric article. As used herein, the phrase “in thermal association” relates to an association between the heating means and one or more components of the fabric article treating device in association with the benefit composition, including the benefit composition itself, such that the benefit composition increases in temperature by at least about 5° C. above the ambient temperature of the air outside of the fabric article drying appliance. Non-limiting examples of components of the fabric article treating device which are in association with the benefit composition include: a reservoir, a conduit, a point of discharge such as a nozzle, and the like.

A. Thermally Conductive Materials:

In one embodiment of the present invention, the benefit composition may be heated by means of a thermally conductive material within the thermal path between the benefit composition and one or more sources of heat. Non-limiting examples of heat sources include: the clothes drying appliance, a heating coil, an exothermic reaction, thermoelectric heating, resistive heating, infrared heating, inductive heating, and the like.

While it is possible to surround the entire fabric article treating device with a thermally conductive material, it may also be beneficial from an economical standpoint to surround only one or more components of the device with the thermally conductive material. Locations for the thermally conductive material include one or more components of the device in thermal association with the benefit composition, non-limiting examples of which include: the source of benefit composition, a conduit, a reservoir, or combinations thereof. Non-limiting examples of the source of benefit composition may include a reservoir, a household water line, a cartridge, a pouch, or the like.

Thermally conducting materials will have a thermal conductivity, or k value, of about 5 W/m*° C. or greater at 25° C. Non-limiting examples of such materials include: metallic materials, ceramic materials, composite materials with thermally conductive fillers, and combinations thereof.

Suitable examples of thermally conductive metallic materials include, but are not limited to: aluminum, copper, tin, silver, and the like. The metallic material may be in the form of a rigid plate, or a malleable sheet of foil and may surround one or more components of the device associated with the benefit composition. The thickness of the metallic materials may be from about 0.1 mm to about 100 mm.

Non-limiting examples of semi-metallic or non-metallic thermally conductive materials include a low thermally conducting material with thermally conductive fillers, such as a polyurethane or polyethylene with a nitride filler material. Non-limiting examples of thermally conductive filler materials include aluminum, copper, magnesium, silver, carbon, graphite, ceramic materials, zinc oxide, aluminum oxide, aluminum nitride, boron nitride, silicone nitride, boron carbide, aluminum carbide, silicone carbide, organosiloxanes, and combinations thereof. The low thermally conducting material may comprise from about 10% to about 80% by weight of a thermally conductive filler material. A suitable commercially available filler material may be obtained from GE Advanced Ceramics of Cleveland, Ohio under the trade name of PolarTherm™. A suitable example of a pre-made mixture of a polymer and a thermally conductive filler material may be obtained from Cool Polymers of Warwick, R.I. under the trademame of CoolPoly® RS012, which is comprised of a polyphenylene sulfide based material and possesses a thermal conductivity of 10 W/mC at 25° C.

Furthermore, the thermally conductive material may be bound to another component of the fabric article treating device with a thermally conductive epoxy or tape. These thermally conductive epoxies and/or tapes typically (but not always) contain a metal or a form of silicone, and serve to further conduct heat. A suitable commercially available example of a thermally conductive epoxy is Epoxy adhesive TC-2707 and a thermally conductive tape is TC-8805, both of which are available from 3M company of St. Paul, Minn.

B. Heating Coils

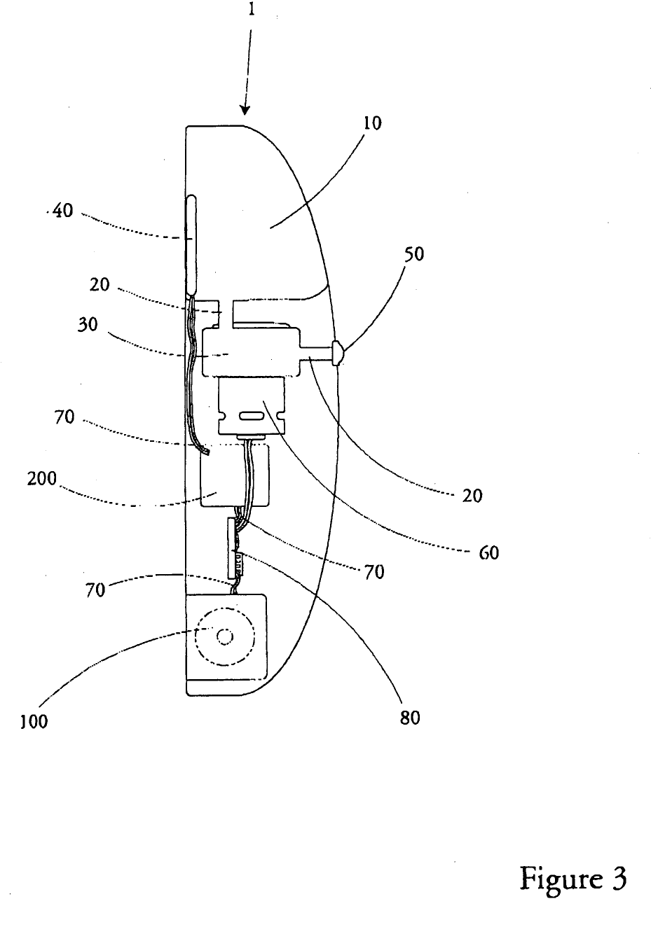

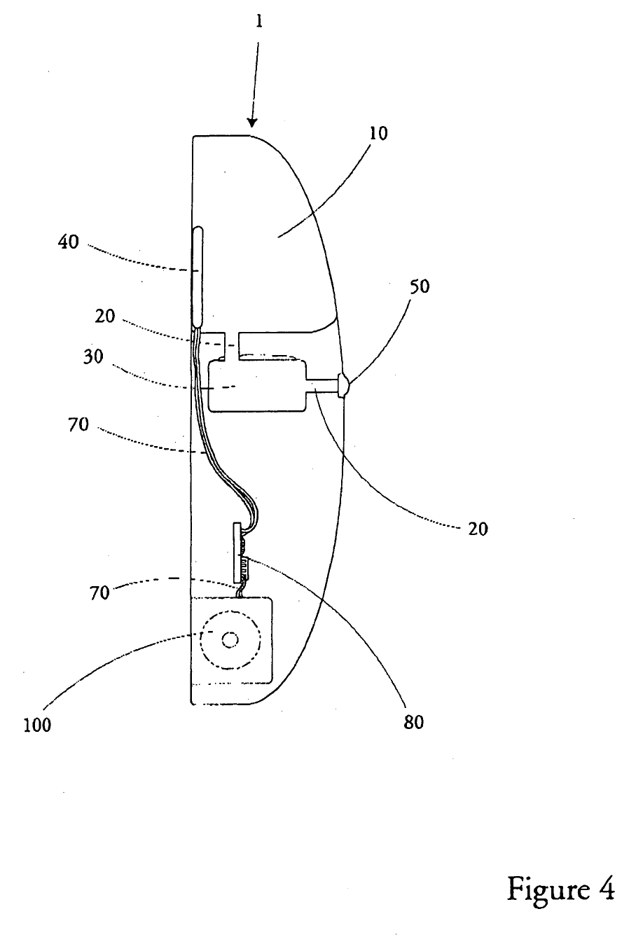

In yet another embodiment of the present invention, heating of the benefit composition may also be achieved by providing resistive heating via a heating coil in thermal communication with the benefit composition and/or one or more components in association with the benefit composition. Referring to FIGS. 3-4, the heating coil 40 may be positioned at any point in and/or on fabric article treating device 1 and/or may be in thermal communication with one or more components in association with the source of the benefit composition 10. The heating coil 40 may be in association with the benefit composition by direct contact, by indirect contact, or by combinations thereof. Non-limiting examples of components of the fabric article treating device which may be in association with the benefit composition include: a reservoir 10, a conduit 20, a point of discharge such as nozzle 50, or a combination thereof.

Furthermore, the heating coil 40 may use a power source 100 such as one or more batteries, a source of household current, and/or the like. If additional current is desired when using batteries as the power source 100, a high voltage power supply 200 may also be used.

Typical materials for the heating coil include, but are not limited to, copper, nickel, niochrome (a nickel and chromium alloy), stainless steel, and the like. In one non-limiting embodiment the benefit composition is heated to a temperature from about 30° C. to about 70° C. by the heating coil.

C. Exothermic Reactions

In still yet another embodiment of the present invention, the benefit composition may be heated by means of an exothermic reaction. The exothermic reaction may take place within the benefit composition, or in a location adjacent to, yet in thermal communication with, the benefit composition.

The exothermic composition may be disposable or reusable. Reusable exothermic compositions may comprise a supersaturated solution of sodium acetate and the like, which may be regenerated by resolubilizing the crystals into solution via heat.

The exothermic compositions may be maintained with a container. Suitable container materials for exothermic reactive compositions include, but are not limited to: polypropylene, polyvinyl acetate, polyethylene, polyurethane, polyvinyl chloride, and the like. The thickness of these materials may be from about 0.1 mm to about 30 mm.

1. Metal Oxidation Exothermic Reactions

The exothermic reaction of metal oxidation requires several components to complete the electrochemical reaction: an anode, a cathode, water, oxygen, and preferably one or more electrolytes. Furthermore, the components of the exothermic reaction comprise a liquid and a solid which are generally stored separately until ready for use. While the anode and cathode are usually solids, the electrolyte may be either in the form of a solid or part of an aqueous solution.

The anode comprises a source of metal, non-limiting examples of which include: a metal powder of iron, copper, magnesium, chromium, manganese, aluminum, zinc, or combinations thereof. The source of metal may have a small particle size, yet a large reactive surface area. Suitable average particle sizes are from about 20 μm to about 1000 μm. The source of metal may be, for example, an iron powder and comprise from about 30% to about 80% by weight of the solid composition.

The cathode of the exothermic reaction may comprise an activated carbon, non-activated carbon, or combinations thereof. The carbon for the cathode may be derived from, but not limited to: coconut shell, wood, charcoal, bone, etc. The cathode may be an activated carbon, with a small particle size and a large reactive surface area comprising from about 3% to about 20% by weight of the composition. Suitable activated carbon will typically have an average particle size of about 201 μm to about 1000 μm and may be obtained under the trademame of Nu Char available from Westvaco of Covington, Va.

The exothermic components may also comprise one or more electrolytes, to further facilitate the reaction by providing electrical conduction between the anode and the cathode. The electrolyte may be in a dry form and in the same container as the anode and/or cathode, or the electrolyte may comprise part of an aqueous solution which is stored separately from the metal powder (anode). Suitable electrolytes are metal salts and include, but are not limited to: alkali metal salts, alkaline earth metal salts, and transition metal salts which includes sulfates, chlorides, carbonates, acetates, nitrates, nitrites, sulfites, chlorates, and the like. Non-limiting examples of electrolytes include: ferric sulfate, potassium sulfate, sodium sulfate, manganese sulfate, magnesium sulfate, cupric chloride, cuprous chloride, potassium chloride, sodium chloride, etc. The electrolyte may comprise sodium chloride, which may be in the form of for example a dry powder contained with the anode, in the concentration of from about 0.5% to about 10% by weight of the solid composition. When the electrolyte is in aqueous solution, concentrations may be in the range of from about 0.1% to about 10% by weight in the aqueous solution.

The exothermic components may also comprise one or more absorbent materials for the purpose of gradually supplying water and/or electrolyte solution to the anode. The absorbent material may be in the same container as the anode and cathode, in a separate container, or combinations thereof. Non-limiting examples of water absorbing materials include: vermiculite, porous silicates, carboxy cellulose salts, wood powder and/or flour, cotton cloth with a high surface area, and the like. The water holding materials may comprise from about 0.1% to about 30% by weight of the solid composition.

In one embodiment, the metal oxidation components are provided in two or more containers. The first container will typically comprise the anode and a cathode and an optional absorbing material. When the electrolyte is in a dry form, it may be present in the same container as the anode and the cathode, and the second container may contain an aqueous solution. In a variation of this embodiment, the electrolyte may be in aqueous solution, and stored in a separate container from the anode, cathode, and optional absorbing material. The aqueous solution, which may be water or an aqueous electrolyte solution, will typically be present in the amount from about 10% to about 50% by weight of the total exothermic components. The second container may be stored within the same compartment as the first container, and may be a pouch which may be pierced by a sharp object such as a pin to initiate the reaction. The addition of the contents of the first and second containers may be achieved by a frangible pouch, whereby the exothermic reaction may be initiated upon the rupturing of the seal between the two containers.

In an alternate embodiment, the solid metal oxidation components may be provided in one container. The container may comprise an anode, a cathode, a solid form of an electrolyte, and optionally a water absorbing material. A user of the device may then initiate the exothermic reaction by adding water to the composition.

2. Saturated Salt Exothermic Reactions:

In still yet another variation of this embodiment, the exothermic reaction may be a reusable supercooled saturated salt solution associated with a metal reaction trigger. The saturated salt solution and metal trigger may be contained within the same container. The metal trigger, when flexed by a user, may subsequently initiate the crystallization of the salt, thereby producing heat. While not wishing to be bound by theory, it is believed that flexing of the metal strip provides minute continuances along the slits or fissures to initiate crystallization. Non-limiting suitable materials for the trigger include: ferrous materials, a beryllium-copper alloy, and the like, and comprises a plurality of slits or fissures. In a non-limiting example, a container comprising a saturated solution of sodium acetate and a ferrous metal trigger is flexed, whereby heat is produced within the range from about 35° C. to about 75° C.

Non-limiting examples of suitable salts for a saturated salt solution include: sodium acetate, calcium nitrate tetrathydrate, and the like. The saturated salt solution may comprise sodium acetate and water, in a ratio of from about 1:1 to about 2:1 by weight. The solution is generally produced by placing the water, salt, and a metal trigger in a pouch which is subsequently sealed. The contents of the pouch are then heated to about 60° C. or higher (for sodium acetate) to bring the salt into solution. Thereafter, the pouch may be supercooled. As used herein, “supercooled” means to cool a substance below the freezing point without solidification and/or crystallization.

After usage, the saturated salt composition may be subsequently regenerated by heating the solution slightly above the melting point of the crystals such that the crystals are re-solubilized. In a non-limiting example, a sodium acetate composition is regenerated by heating the composition to about 60° C. or higher, such that the crystals from the exothermic reaction are resolubilized. Non-limiting suitable means of re-heating the solution include a microwave, immersion into boiling water, and the like.

3. In-Situ Exothermic Reactions

In still yet another variant, the exothermic reaction components may comprise the benefit composition itself, whereby the benefit composition may act as a component for the exothermic reaction. As used herein, the phrase “in-situ exothermic compositions” refers to compositions that are comprised of the benefit composition itself and are dispensed from the fabric article treating device such that the composition is dispensed within the fabric article drying appliance and/or onto the fabric article(s). In-situ exothermic reactions comprise a solute and solvent, wherein the solvent is typically (but not always) aqueous in nature. The addition of a solvent may occur concurrently, prior to, and/or subsequent to the addition of a solute, whereby heat is provided by the exothermic reaction. The addition of the solvent may occur prior to the addition of the solute and occurs within the source of the benefit composition. In alternate embodiments, the addition of the solute and solvent may occur outside of the source of benefit composition, and be subsequently added to the source. In still yet another embodiment, the solute and solvent are contained in discrete reservoirs (sources of benefit composition), wherein the solute and solvent are conveyed to a common conduit and the two or more components are mixed. The solvent may be present in the reaction in the amount from about 50% to about 99.9% by weight, and is typically, but not always, aqueous in nature.

Non-limiting examples of suitable exothermic reactions involving the addition of water to a system include: dissolution, hydration, acid dissociation, and the like. Exothermic reactions may have an enthalpy of −1 kJ/mole or less when measured at 25° C., or preferably may have an enthalpy of −5 kJ/mole or less at 25° C. The enthalpy of a reaction may in general be obtained by subtracting the sum of the enthalpies for the reactants from the sum of the enthalpies for the products, which may be found in any suitable reference book known to those of ordinary skill in the art, such as “The Handbook of Chemistry and Physics”, “Perry's Chemical Engineer's Handbook”, and the like. Examples of exothermic dissolution reactions often involve the addition of one or more solutes to a solvent, the solutes being present in an amount from about 0.1% to about 50% by weight of the of the composition. The solute may be a solid, gas, a liquid, or combinations thereof. In alternate embodiments, the solute may be added subsequent to the addition of a solvent such as water, but may also be added concurrently and/or prior to the addition of the solvent. Non-limiting suitable examples of solutes which are exothermic in water include: ammonia (gaseous state), sodium hydroxide, lithium bromide, sodium acetate, potassium acetate, potassium hydroxide, zinc chloride, and the like.

Examples of non-aqueous exothermic reactions include, but are not limited to the addition of: lauric acid to carbon tetrachloride, urethane to chloroform, urethane to methanol, acetone to acetic acid, heptane to isobutanol, and the like. In alternate modes of operation, the temperature of the clothes drying appliance is lower than the flashpoint of the solvent and/or solute.

Exothermic dilution reactions on the other hand, involve the addition of supplemental solvent to the composition whereby heat is generated. Acids may be used for exothermic dilution reactions with the addition of an aqueous solvent (such as water). Non-limiting examples of suitable acids include: nitric acid, sulfuric acid, hydrochloric acid, maleic acid, picric acid, acetic acid, and combinations thereof.

D. Thermoelectric Modules

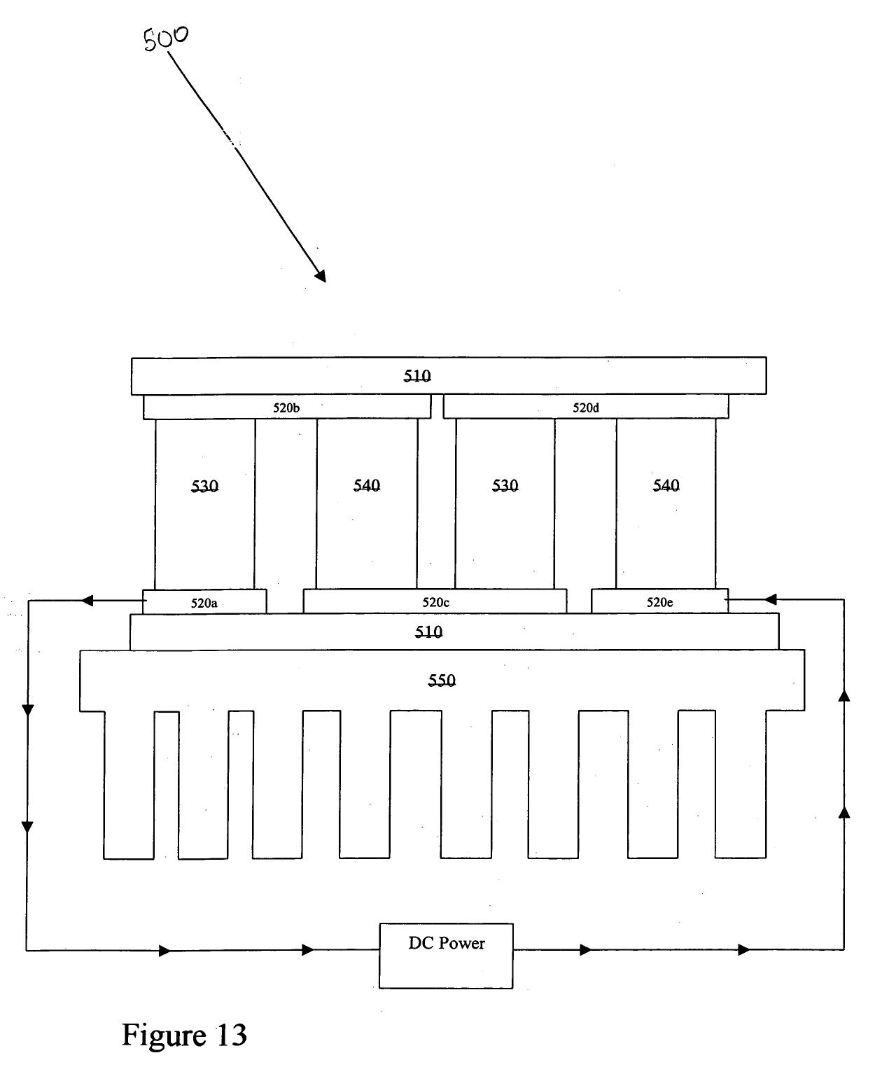

Heating of the benefit composition may also be accomplished by using a thermoelectric module, such as that achieved by a reverse Peltier module. As used herein, the phrase “reverse Peltier module” refers to utilizing a Peltier module wherein the heat sink is in thermal communication with the benefit composition and/or one or more components of the fabric article treating device associated with the benefit composition, non-limiting examples of such components including: the source of benefit composition, a conduit, the nozzle, and the like. In general, the reverse Peltier module/Effect may be achieved by applying voltage to a module whereby heat is moved from one side of the module to another by electron movement. Without wishing to be bound by theory, it is believed that the reverse Peltier module operates in the following manner as illustrated by the schematic of FIG. 13:

1) a module 500 comprises at least one conducting material which is preferably a negative semi-conductor material 530, and at least one dissimilar conducting material which is preferably a positive semi-conductor material 540, which are connected electrically in series yet thermally in parallel, and are sandwiched between two ceramic substrates 510 which are positioned between a component(s) to be heated and a heat source such as a fabric article drying appliance (not shown); 2) the application of DC power to an electrical interconnect 520e cause electrons to flow to a positively doped semi-conductor material 540, which absorbs heat at an electrical connection 520d between the component to be cooled and the junction between the positively doped semiconductor material 540 and the negatively doped semiconductor material 530; 3) the electrons then flow through the negatively doped semi-conductor material 530 to an electrical connection 520c whereby heat is transferred to a second junction between the negatively doped semi-conductor material 530 and to another positively doped semi-conductor material 540; and 4) the heat is transferred from this second junction 520c to the heat sink 550 which is in thermal communication with the source of benefit composition (or another component associated with the benefit composition), thereby transferring heat from the drying appliance to the component associated with the benefit composition.

Each module 500 for the Peltier Effect is constructed of at least one conducting material and another dissimilar conducting material. While the conducting materials may comprise different metals, in preferred embodiments the module 500 comprises at least one negatively doped semi-conductor material 530 and at least one positively doped semi-conductor material 540. The negatively and positively doped semi-conductor materials are connected electrically in series, yet thermally in parallel. Furthermore, the semi-conductors (530 and 540) and their electrical interconnects 520 are bridged between two ceramic substrates 510. The first ceramic substrate 510 is in thermal communication with both the component(s) to be cooled and the semi-conductor materials (530 and 540). The second ceramic substrate 510 is in thermal communication with the semi-conductor materials (530 and 540) and the source of heat. The heat sink 550 is further in thermal communication with one or more components in association with the benefit composition, whereupon application of current to the semi-conductor materials the accumulated heat is carried to the benefit composition and/or one or more components of the device in thermal association with the benefit composition. More than one module 500 may be used for a greater heating effect, if stacked in parallel.

In general, the semi-conductor material is often, but not always, an alloy of bismuth telluride, lead telluride, silicon germanium, and/or bismuth antimony. The semi-conductor material may comprise a crystalline bismuth telluride, of both the P-type and N-type in equal and discrete proportions, although other ratios are also effective. As used herein, “N-type” semi-conductors material are of the negative type, doped with an excess of electrons than needed to create a perfect molecular lattice structure; whereas “P-type” semi-conductor materials are of the positive type, doped with a deficit of electrons needed to create a perfect molecular lattice structure. While not wishing to be bound by theory, it is believed that the extra electrons of the N-type material and the “missing” electrons (or holes) from the P-type materials facilitate the transfer of heat energy from end of the semi-conductor material to another.

The heat sink 550 is typically finned, in a manner such that the surface area of the material is maximized. The heat sink may be constructed of aluminum, copper, silver, and the like, although other conductive materials may also be used.

The DC power source may be any power source, such as a source of household current, batteries, and the like. In general, the power applied to the module may be about 12V, although higher values may be used if a greater heat transfer effect is desired.

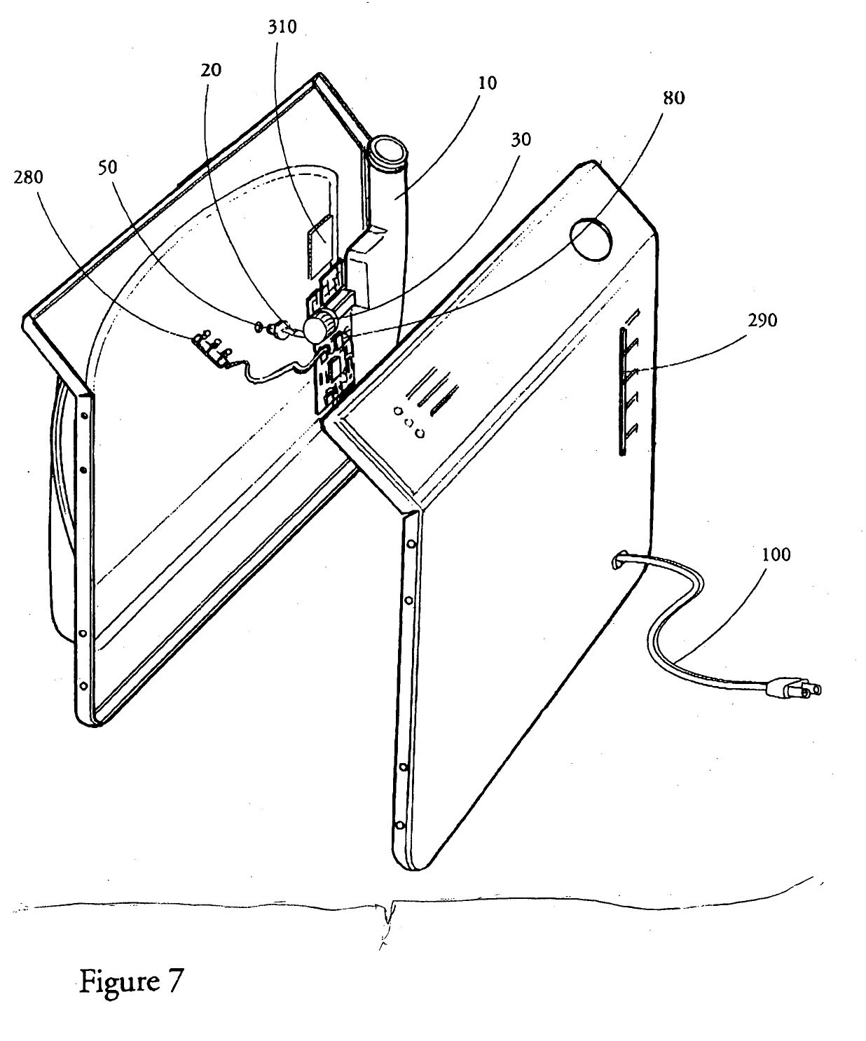

Referring to FIG. 7, a reverse Peltier module 310 is positioned between the source of benefit composition 10 and the interior panel of the door of the device 1. The heat sink of the Peltier module 310 is positioned adjacent to the source of benefit composition 10, whereby the heat from the fabric article drying appliance (not shown) is subsequently transferred to the source of the benefit composition 10. In this embodiment of the present invention, the surface of the fabric article treating device 1 facing the interior of the fabric article drying appliance is constructed of thermally conductive material, preferably of metal. The Peltier module 310 may be placed on other components of the device 1 in association with the benefit composition, non-limiting examples of which include a nozzle 50, or a conduit 20. One example of a thermoelectric module utilizing the Peltier Effect is model 6302/127/060AX, which may be obtained from Ferrotec America Corporation of Nashua, N.H.

Power Source

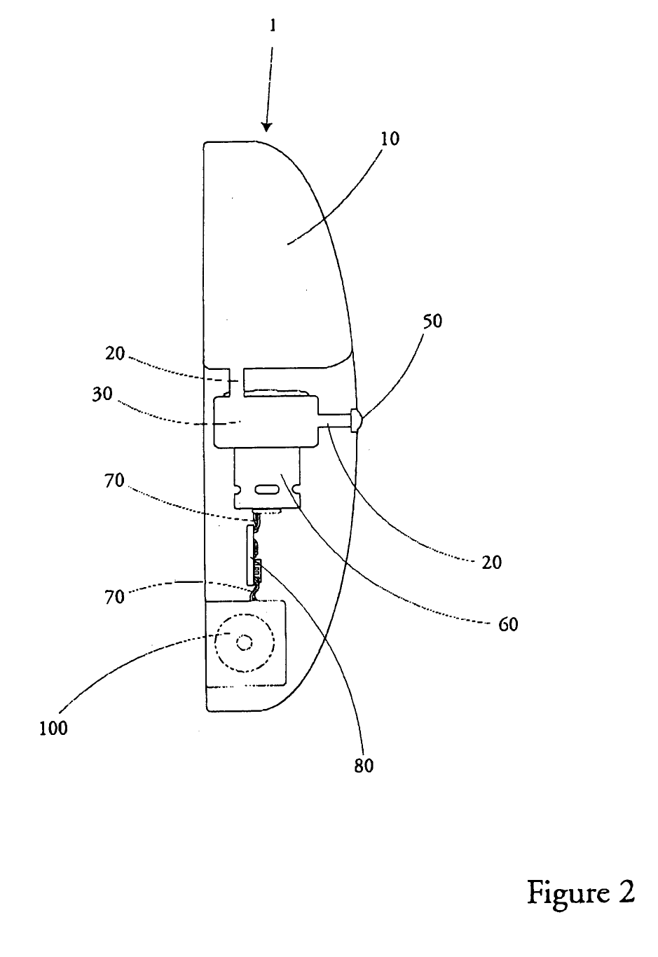

Referring to FIG. 2, the fabric article treating device 1 may comprises a power source 100 for supplying power to components of the fabric article treating device 1. Non-limiting examples of these components include: the circuits 80, a motor 60 for the dispensing means 30, and combinations thereof. Non-limiting examples of suitable power sources 100 include: batteries of the reusable or disposable type, solar power, a source of household current, and the like. When using batteries as the power source 100, one or more of the batteries may be of the rechargeable or disposable type. Suitable and readily available batteries include, but are not limited to: alkaline batteries, lithium batteries, and the like. An example of a suitable alkaline battery is an Energizer No. E95, a 1.5V Zn/MnO₂ D Cell battery which can be obtained from Eveready Battery Company of St. Louis, Missouri.

Source of Benefit Composition

The fabric article treating device 1 additionally comprises one or more sources of a benefit composition 10, which is associated with the device 1 so as to provide a benefit composition for dispensing within the fabric article drying appliance. The source of benefit composition 10 may be a reservoir, cartridge, pouch, conduit, household water line, or the like. Additionally the source of benefit composition 10 may be a refillable and/or non-refillable container that has a finite amount of liquid contained therein. In even another embodiment, the source of benefit composition may be both a household water line and a refillable and/or non-refillable container. The source of benefit composition 10 may be fixably attached to the fabric article drying appliance or it may be removably attached.

The source 10 may comprise a first reservoir for containing the benefit composition, and may additionally comprise more than one reservoir to be dispensed simultaneously or separately with the contents of said first reservoir.

The source 10 may also be constructed of a rigid, semi-rigid, and/or flexible material. Should the source of benefit composition 10 be primarily constructed of a rigid or semi-rigid material, these embodiments may additionally comprise a venting means so as to permit the ready flow of the benefit composition to the dispensing means 30.

Dispensing Means

The dispensing means 30 may be motorized or non-motorized. Generally, the dispensing means 30 of the fabric article treating device 1 may be accomplished by utilizing a motorized pump. One non-limiting example of a motorized pump, is one which uses hydraulic pressure such as a peristaltic pump. Other non-limiting motor driven pumping mechanisms which may be used include gear, diaphragm, centrifugal, or piston pumps. Generally, a suitable pump will have an operating pressure in the range of from about 1 to about 2,000 kPas, although pressures between 50 and 1500 kPas, and/or from about 140 to about 1050 kPas and/or 100 to 500 kPas can be used.

Referring to FIG. 4, the dispensing means 30 may be of the non-motorized type to conserve the energy used from the power source. Non-limiting examples of a non-motorized dispensing apparatus includes: springs, pressurized reservoirs, elastic vessels, memory shape alloys, gravity feeding mechanisms, capillary action, propellants, syringes, gas (both pre-pressurized and/or generated in-situ), and the like. A suitable example of a non-motorized dispensing apparatus 30 is a piezo pump of the “LPD series, which may be obtained from PAR Technologies LLC of Hampton, Va.

High Voltage Power Supply (HVPS)

Referring to FIG. 3, the device may also comprise a high voltage power supply (HVPS) 200, which is optionally used for transforming current to supply power for the heating coil 40. Typically (but not always) the power source 100 is one or more batteries with a voltage of 9V or less, and the heating coil may or may not require additional voltage for the desired temperature. A non-limiting example of a suitable miniature, regulated high voltage power supply 200 is a model in the C series such as the C50, C60, or C80 which can be obtained from EMCO High Voltage Corporation located in Sutter Creek, Calif. Other suitable high voltage power supplies 200 include piezo transformers, which utilize a unique mechanical energy storage system for transforming power. These piezo transformers are of particular use when utilizing ultrasonic nebulization. Piezo transformers may be obtained from Fuji & Co. of Japan.

Nozzles

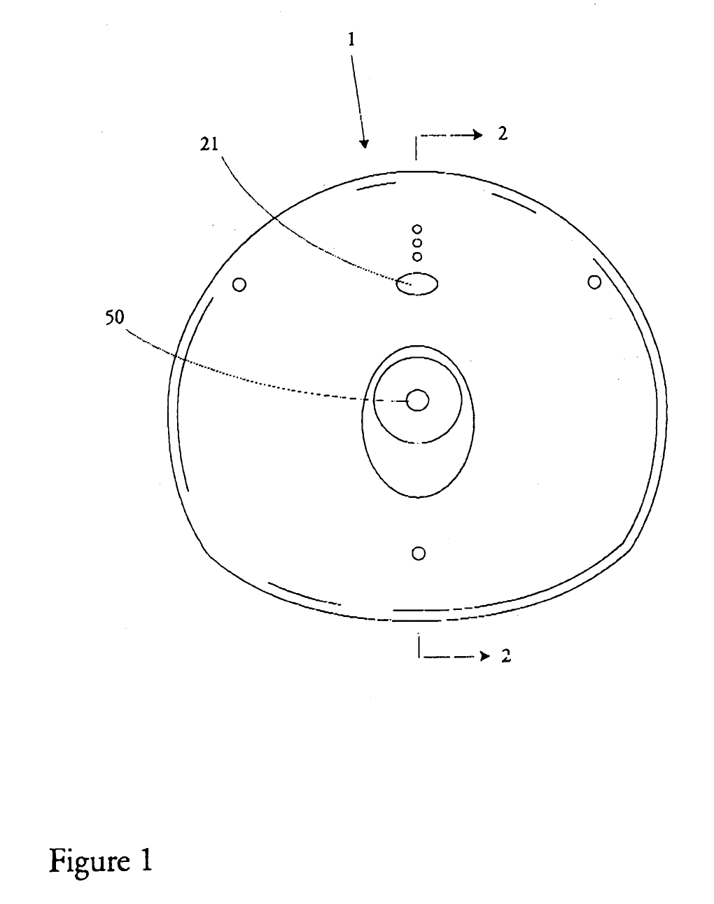

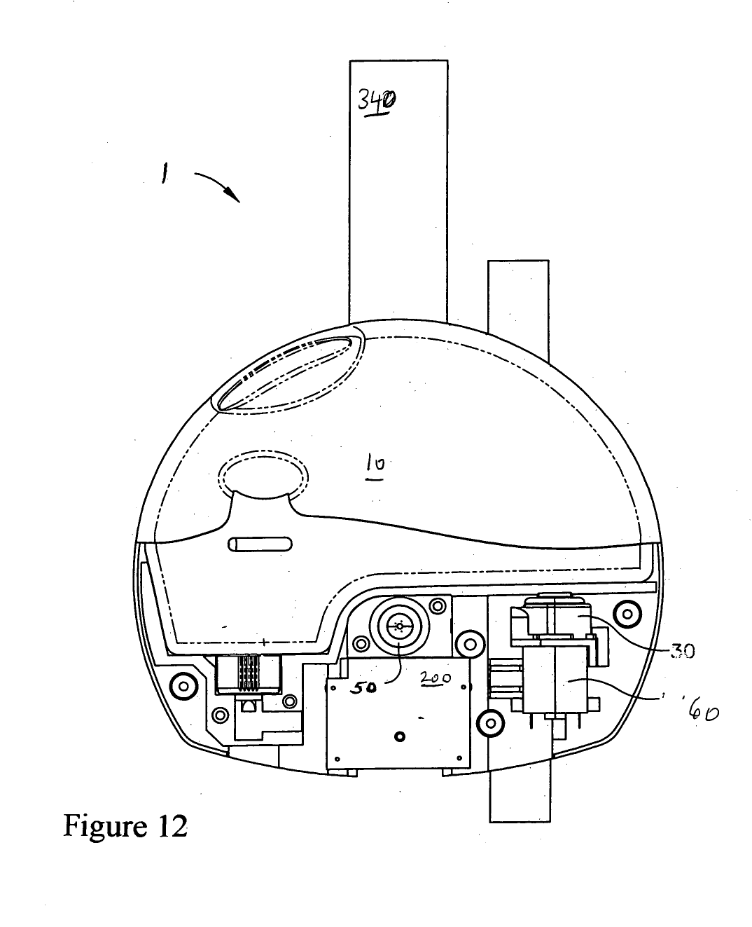

Referring to FIGS. 1-9 and 12, the fabric article treating device 1 may also, and typically does, comprise a nozzle 50 through which the benefit composition passes during delivery to the fabric article and/or the interior region of the fabric article drying appliance.

The nozzle 50 may be an atomizing nozzle. The misting of the benefit composition can be achieved using any suitable spraying device such as a hydraulic nozzle, sonic nebulizer, high pressure fog nozzle or the like to deliver the benefit composition. The misting may be accomplished using a relatively low volume air atomization nozzle and/or a simple orifice. For example, spray nozzles commercially available from Spray Systems, Inc. of Pomona, Calif. (Model Nos. 850, 1050, 1250, 1450 and 1650) are suitable. In an alternative embodiment, the composition is may be delivered via more than one spray nozzle.

In some embodiments, the spray nozzle 50 may use a pressure swirl atomizer similar to ones used in trigger sprayer nozzles, but may incorporate a fan atomizer, or an impingement or screen foamer. An example of a suitable atomizing nozzle is a pressure swirl atomizing nozzle made by Seaquist Dispensing of Cary, Ill. under the Model No. of DU-3813. In another embodiment, the composition is delivered though a pressurized spray system.

Optionally, filters and/or filtering techniques can be used to filter the benefit composition if desired. This may be desirable when using a heated benefit composition as repeated heating of the composition may cause concentration of the composition which may possibly lead to particulate formation. Non-limiting examples of filters and/or filtering techniques include: utilizing a filter in the treating device 1 prior to the nozzle 50; filtering the benefit composition prior to dispensing into the benefit composition reservoir 10; centrifuging the benefit composition prior to dispensing into the benefit composition reservoir 10; and the like; or combinations thereof.

In alternate embodiments, the nozzle 50 comprises a filter (not shown) prior to the orifices, introduced for the purpose of reducing the possibility of clogging of the orifices. The design of the nozzle 50 may be such that the filter and spray-head are detachable either separately or as a unit from the remainder of the assembly for the purpose of cleaning and replacement thereof. The filter may have a pore size equal to or less than the greatest outlet diameter of the nozzle orifice.

Signaling Means

Further yet, the device may comprise a signaling means to communicate with a user of a device such as visual, auditory, vibrational signals, or combinations thereof. Non-limiting examples of signaling means include: flashing lights, colored lights non-limiting examples of which include green/red lights, beeps, whistles, chimes, and vibrations. The signaling means may be useful for indicating the status of the device, which in turn may require the user to actuate a feature of the device.

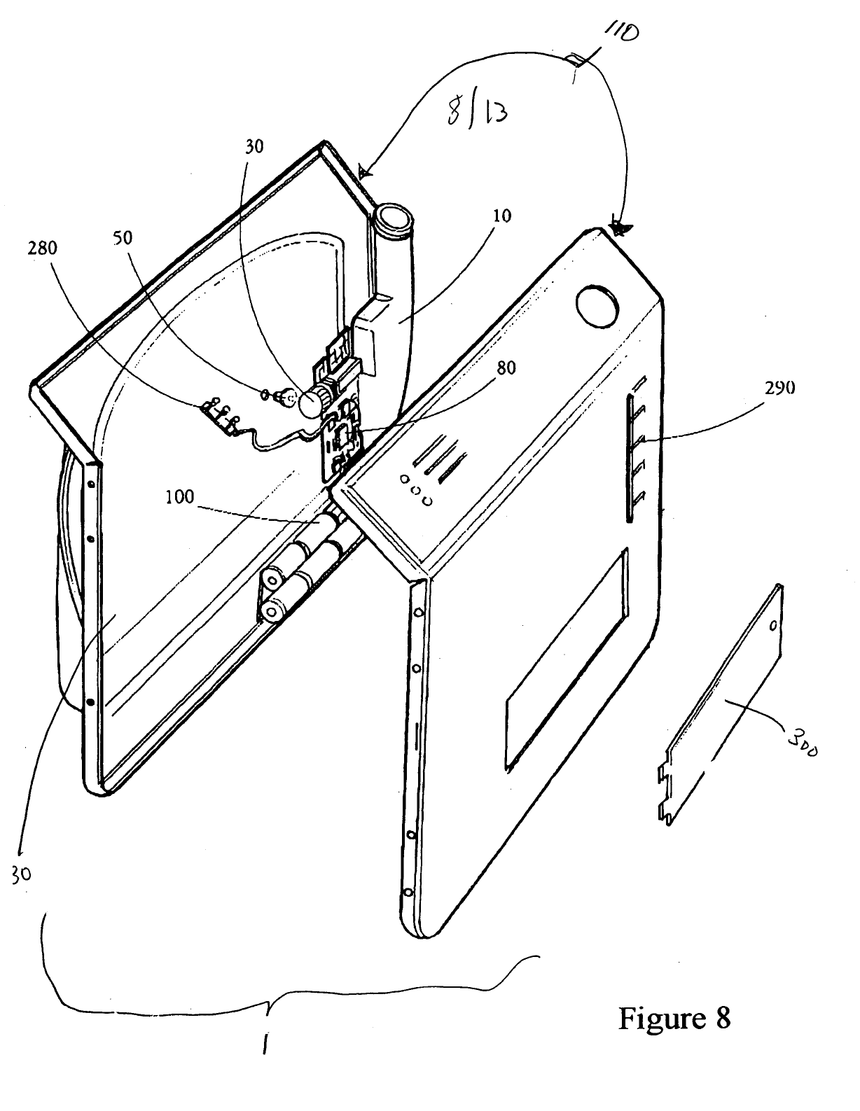

Referring to FIGS. 7 and 8, a non-limiting example of signaling means are illustrated. The LED lights 280 which are visible from the exterior surface of the fabric article drying appliance closure structure may have different colors to indicate an operating condition: inter alia a green LED light for when the device is in operation, or perhaps a flashing red light to indicate a low battery state.

Benefit Composition

The benefit composition may comprise one or more fabric article actives and may be a cleaning, dewrinkling, finishing and/or deodorizing composition, and the like. Furthermore, the benefit composition may be in the physical form of a liquid, solid, gas, or combinations thereof. Non-limiting examples of fabric article actives include solvents, surfactants, wrinkle releasing agents, anti-static agents, anti-shrinking agents, antimicrobial agents, wetting agents, crystal modifiers, soil release agents, colorants, brighteners, perfume, odor reducers/eliminators, deodorizer/refresher, stain repellents, color enhancers, starch, softeners, and sizing agents.

The benefit composition may comprise water, surfactants, perfumes, preservatives, bleaches, auxiliary cleaning agents, anti-shrinking agents, solvents, anti-wrinkling agents, antibacterial agents, wetting agents, crystal modifiers, and mixtures thereof.

Typical benefit compositions herein may comprise at least about 50%, by weight of water, preferably at least about 65%, and more preferably at least about 80% water.

One challenge of spraying the benefit composition into the fabric article drying appliance is the possibility that the benefit composition may plug the nozzle(s) between uses. Several approaches can be used to prevent this plugging, including but not limited to; using single phase solutions, including higher levels of humectants or other moisture retaining ingredients, hydrophilic solvents, using film softening ingredients with polymers, and the addition of hygroscopic salts to the benefit composition.

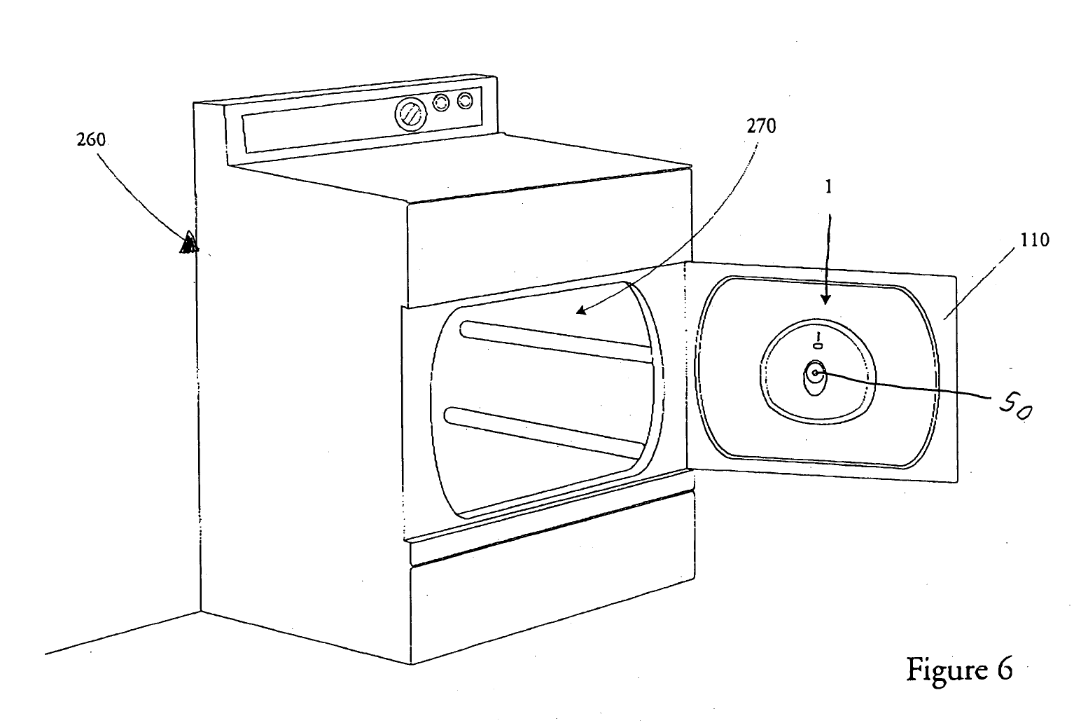

Now referring to the drawings, specifically to FIG. 6, there is illustrated a fabric article treating device 1 for treating fabric articles according to the present invention. The fabric article treating device 1 is associated with a fabric article drying appliance 260 in a manner such that one or more benefit compositions are dispensed into the interior 270 of the fabric article drying appliance 260 and/or dispensed onto the fabric article(s) present in the interior 270 of fabric article drying appliance 260. In one embodiment, the contact may occur while the fabric articles are in motion. In another embodiment, the contact may occur while the fabric articles are not in motion. In even another embodiment, the contact may occur while the fabric articles are at one point in motion and at another point in time not in motion. The fabrics may be in a wet or dry state upon treatment.

In general, the fabric article treating device 1 may be removably or permanently attached to the interior 270 of the fabric article drying appliance 260. Non-limiting examples of possible areas of attachment include the closure structure 110 of the fabric article drying appliance 260, a drum (if there is one) of the fabric article drying appliance 260, the rearward wall, and the like. Non-limiting examples of attachment means include: suction cups, hooks, straps, adhesive, Velcro®, magnets, and the like. In yet another embodiment as illustrated by FIGS. 7-8, the fabric article treating device 1 may be incorporated into a readily detachable closure structure 110 suitable for use with a fabric article drying appliance.

Referring to FIGS. 1-2, there is illustrated a fabric article treating device 1 for treating fabric articles according to one aspect of the present invention. In this embodiment, the reservoir 10 is constructed of a thermally conductive material, whereby the benefit composition is heated via a heat source, such as the fabric article drying appliance (not shown). In a non-limiting example, the reservoir 10 is constructed of a suitable material with a thermal conductivity of 10 W/m° C. at 25° C. such as a polyphenylene sulfide based material under the tradename of CoolPoly® RS012, which may be obtained from Cool Polymers of Warwick, R.I. In a typical operation, once the fabric article drying appliance is operated in the prescribed manner, and subsequently and/or during the commencement of the treatment cycle, the fabric article treating device 1 is activated. In one embodiment, the device 1 is activated subsequent to the operation of the fabric article drying appliance, preferably at least about 5 minutes after the commencement of the drying cycle.

The fabric article treating device 1 may be activated by depressing a switch 21 which subsequently activates the motor 60 of the pump 30. The motor 60 is generally, but not always, powered by the power source 100, which typically comprises one or more batteries. The power source 100 may be connected to the motor 60 by electrical wiring 70 and an optional electronics board 80 for controlling the motor 60.

Once the pump 30 is activated, a heated benefit composition is drawn from a reservoir 10 through a conduit 20 to the nozzle 50. Inner diameters for the conduits may be from the range of about 10 mm or less, and/or about 5 mm or less. Optionally, the conduit 20 additionally comprises a filter prior to the nozzle 50. The filter pore size may be equal to or less than the widest orifice of the nozzle 50.

The nozzle 50 may be a fluid atomizing spray head and/or even a simple orifice through which the benefit composition is dispensed within the receiving volume of the clothes drying appliance. A suitable pressure swirl atomizer may be obtained from Seaquist Dispensing LLC of Cary, Ill. under the Model No. of DU-3813.

In another embodiment of the present invention as illustrated by FIGS. 3-4, the operation of the device is performed in a similar manner to that of the embodiment illustrated by FIGS. 1-2. In this embodiment, the heating of the benefit composition is achieved by means of a heating coil 40 positioned within the reservoir 10. The heating coil 40 may be positioned within, or within thermal association with, any component of the device associated with the benefit composition. Non-limiting examples of components in association with the benefit composition include: a reservoir 10, a conduit 20, a point of discharge such as the nozzle 50, and combinations thereof.

In this embodiment, the power is provided by one or more batteries 100 and optionally by a high voltage power supply 200 which provides power to the heating coil 40 which subsequently heats the benefit composition.

The embodiment represented by FIG. 4 operates in a similar manner to the embodiment of FIG. 3, and is a more economical version thereof. In order to conserve energy of the power source 100, the dispensing means 30 is of the non-motorized type, non-limiting suitable examples of which include spring actuated devices, gravity feed pumps, and the like. Additionally, the heating coil 40 may be powered solely by batteries 100, without the need for a high voltage power supply.

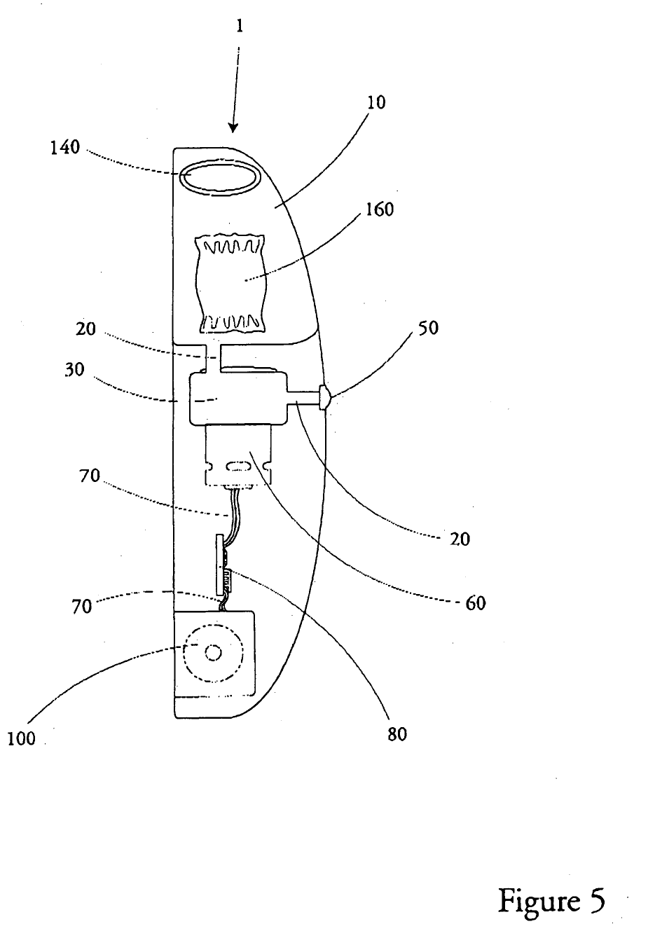

The embodiment illustrated by FIG. 5 heats the benefit composition by means of an exothermic reaction. In this embodiment, an exothermic pouch 160 may be flexed and subsequently added through the reservoir opening 140 to provide heat to the benefit composition in the reservoir 10. Non-limiting examples of exothermic pouches include those of metal oxidation reactions, saturated salt solutions, and the like. In alternate variations of this embodiment, the exothermic reaction may be generated in situ, wherein a solute is added directly to the benefit composition in the reservoir 10, whereby heat is generated. The solute may be added prior to, subsequent to, in concurrence with the solvent, or combinations thereof. Additionally, the solute and solvent may be mixed prior to the placement within the reservoir 10, and subsequently dispensed therein.

The embodiment depicted by FIG. 7 heats the benefit composition by means of a thermoelectric module 310. The thermoelectric module 310 uses a power source 100 such as a source of household current, and is positioned such that the heat sink of the module is in thermal communication with the one or more sources of benefit composition 10. Furthermore, the interior panel of the device is constructed of a thermally conductive material such as steel. Heat is transferred from the fabric article receiving volume of the fabric article drying appliance to the thermoelectric module 310, such as a Peltier module, which subsequently transfers the heat to the benefit composition(s). The thermoelectric module may also be in thermal communication with other components associated with the benefit composition, non-limiting examples of which include: a conduit 20, a point of discharge such as a nozzle 50, and the like. One example of a module utilizing the Peltier Effect is model 6302/127/060AX, which may be obtained from Ferrotec America Corporation of Nashua, N.H.

An advantage of the embodiment depicted by FIG. 7 is that the fabric article treating device 1 is integrated with a drying appliance closure structure. The fabric article treating device 1 may be readily exchanged with an existing appliance door by simply unscrewing the existing closure structure, and attaching the fabric article treating device 1 of the present invention. This provides the convenience of an integrated fabric article treating device, yet does not necessitate complicated and/or expensive retrofitting of an existing appliance.

This embodiment also provides means to signal to a user of the fabric article treating device 1 by means of LED lights 280 or the reservoir window 290. The LED lights 280 might for example exhibit a green light to show an operating state, or a flashing red light to indicate a deleterious operating condition, such as a low amount of benefit composition, which may lead to unsatisfactory results. The level of benefit composition may also be perceived through the reservoir window 290, which may also be marked with dosage indicia, indicating the number of usages remaining. Furthermore, the temperature of the benefit composition might also be indicated.

The embodiment of FIG. 8 is similar in outward appearance to the embodiment of FIG. 7, yet provides heat to the benefit composition in a similar manner to the embodiment of FIG. 2. The embodiment of FIG. 8 comprises access panel 300, an inner panel 230 of the fabric article treating device constructed of a thermally conductive material, such as steel, and a source of benefit composition 10 constructed of a thermally conducting material, such as a polyphenylene sulfide based material with a thermal conductivity of 10 W/m° C. at 25° C. under the tradename of CoolPoly® RS012, which may be obtained from Cool Polymers of Warwick, R.I. In this embodiment, the heat from the operation of the fabric article drying appliance is transferred to the inner panel 230 of the fabric article treating device 1 to the source of the benefit composition 10, which thereby provides heat to the benefit composition.

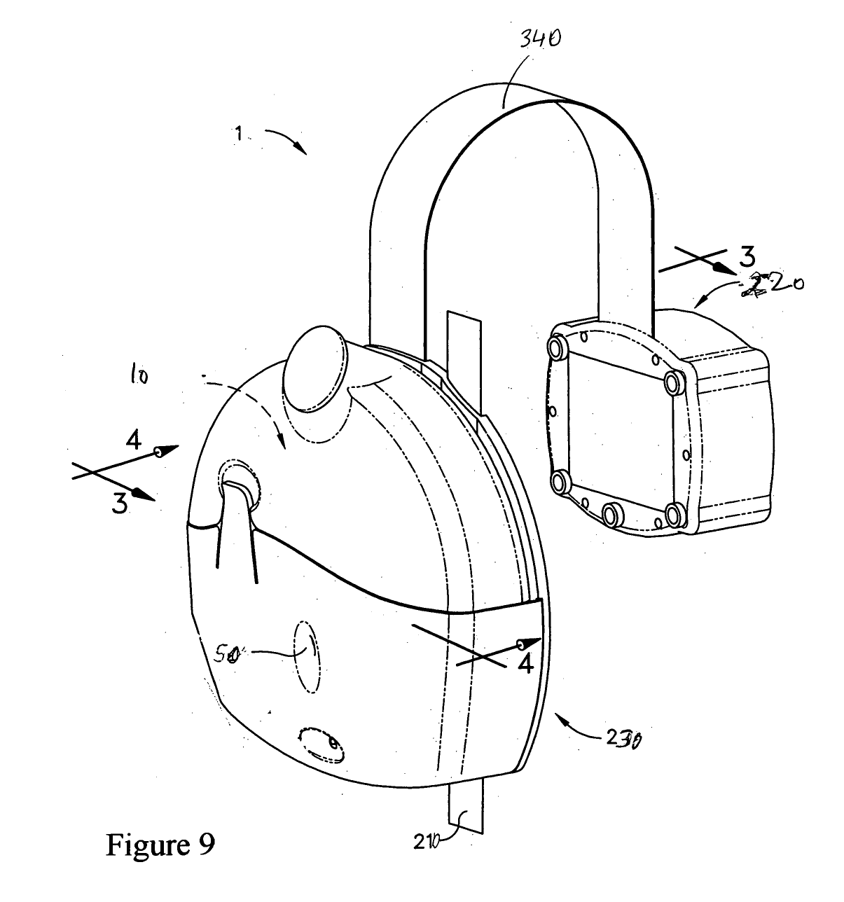

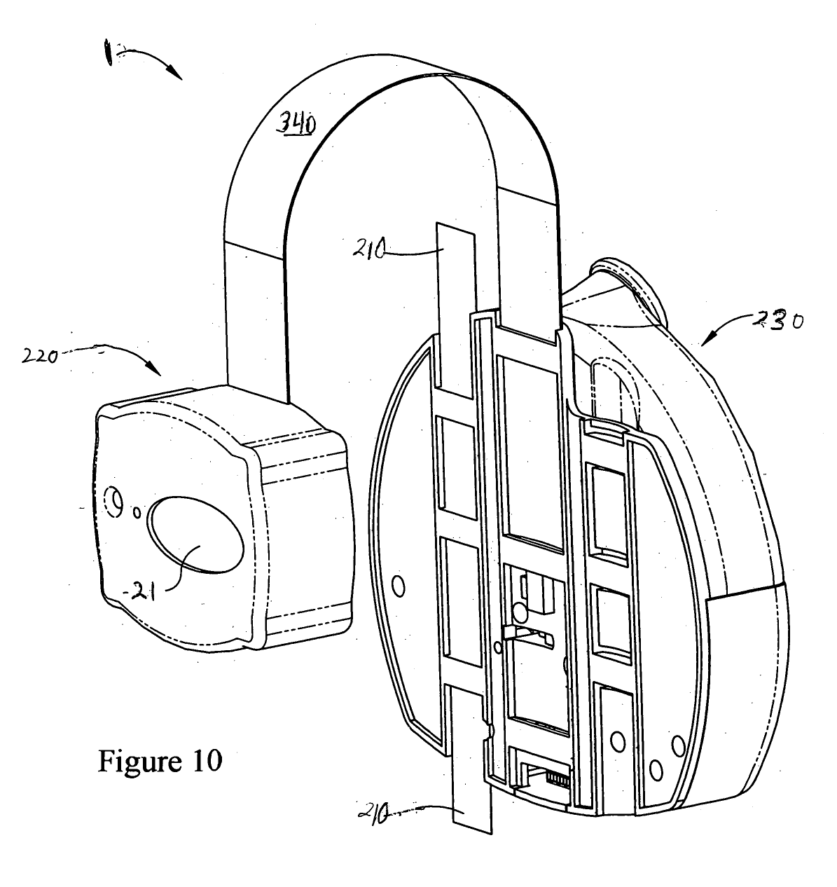

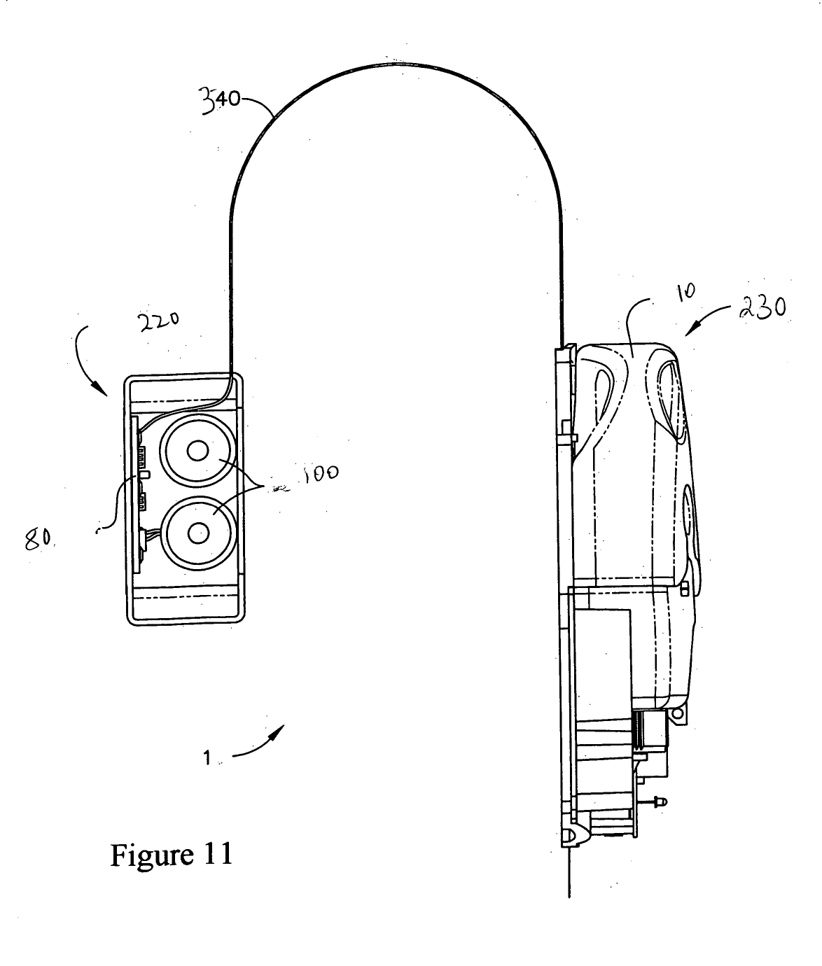

FIGS. 9-12 depict an alternate embodiment of the fabric article treating device 1. The fabric article treating device 1 comprises two housings or enclosures an inner or interior housing and an outer or exterior housing. Inner housing 230 is located in the interior of a fabric article drying appliance. Exterior housing 220 is located outside of a fabric article drying appliance. The inner housing 230 and exterior housing 220 of fabric article treating device 1 are in communication with each other. Non-limiting examples of communication between the inner housing 230 and exterior housing 220 include electrical communication (wherein electrical signals are transferred between the interior and outer housing) and compositional transfer communication (i.e.; wherein a benefit composition is transferred between the outer and inner housing), and thermal communication (i.e.; wherein temperature differentials are transferred between the outer and inner housing a non-limiting example of which is wherein the benefit composition is heated in one housing and transferred to the other housing). The inner housing 230 and exterior housing 220 may be connected to one another. Non-limiting means of connecting the inner and outer housing include a flat cable, a wire, and/or a conduit 340 (a non-limiting example of which is a conduit for transferring benefit composition between the outer and inner housing). Inner housing 230 may be mounted to the closure structure of a fabric article drying appliance by mounting strap 210.

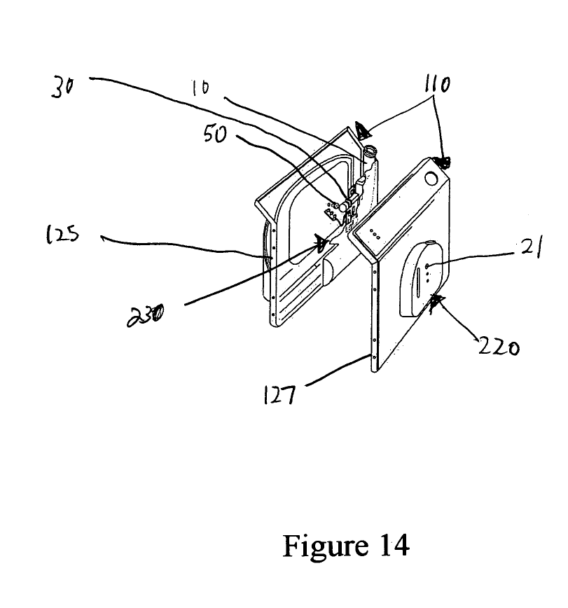

The exterior housing 220 may be mounted on the exterior surface of the fabric article drying appliance door, yet may also be mounted on any exterior surface, non-limiting examples of which include: the side walls, the top walls, the outer surface of a top-opening lid, and the like, including a wall or other household structure that is separate from the fabric article drying appliance. Furthermore, the interior housing 230 may be mounted on any interior surface of the fabric article drying appliance, examples of which include, but are not limited to: the interior surface of the door, between the interior surface 125 and exterior surface 127 of the closure door 110 as shown in FIG. 14, the drum of the fabric article drying appliance, the back wall, the inner surface of a top-opening lid, and the like.

The interior and exterior housings may be constructed of materials familiar to those of ordinary skill in the art. Non-limiting examples of such materials include polymeric materials including but not limited to polyurethane, polypropylene, polycarbonates, polyethylene, and combinations thereof and metals including but not limited to enameled metals.

Exterior housing 220 may be permanently mounted to the exterior surface, or releasably attached to the exterior surface. Likewise, enclosure 20 may be permanently mounted to the interior surface, or releasably attached to the interior surface.

The inner housing 230 and the outer housing 220 are in communication with one another. The inner housing 230 and outer housing 220 may be connected to one another. Non-limiting examples of connecting the inner housing 220 and the outer housing 230 may include utilizing a flat cable 340 (also sometimes referred to as a “ribbon cable”) as shown in FIGS. 9-12, a wire, a wire or group of wires encased in a sheath of woven or non-woven material, a conduit (a non-limiting example of which is a conduit for the benefit composition, or a combination thereof. The woven or non-woven sheath may also be used as a method of attaching inner housing 230 and outer housing 220. The inner housing 230 and outer housing 220 may be used to provide a means of gravitational counter-balancing so as to reduce unnecessary tension on the wires and/or the housing connections. Typical weight ratios between the inner housing 230 and the outer housing 220 are generally from about 1:14 to about 14:1. The inner housing 230 and outer housing 220 may also be in electrical and/or fluidic communication. A reservoir 10 for the benefit composition, a means for heating the benefit composition, a pump 30, and discharge nozzle 50 are also present. The pump 30 may include a motor 60. A power supply 200 may also be included. Additional electronic components 80 may also be included.

In a non-limiting example of a use of the fabric article treating device 1 as shown in FIGS. 1-2, and 6 one or more fabric articles may be placed in the interior 270 of the fabric article drying appliance 260. The operator simply depresses an on/off switch 21 on the fabric article treating device 1 for a short period. The drying appliance 260 is activated in a manner prescribed by the manufacturer. After a pre-set time period or commencement of an environmental condition, the on/off switch 21 activates the electronics 80 of the device to connect the batteries 100 through wire 70 and the pump motor 60.

The benefit composition is conveyed from a reservoir 10 through the dispensing means 30 and the conduit 20, and is discharged from nozzle 50 into the fabric article drying appliance 260. The benefit composition may be discharged from nozzle 50 in the form of a mist. In general, the time for applying the benefit composition may be between about 0.5 to about 120 minutes, depending on the choice of cycle and the load size. The temperature of air during the treatment period may be in the range from about 30° C. to about 80° C., more preferably from about 40° C. to about 65° C. The exhaust duct may be connected with duct work such that the exhaust air is vented out of the user's home as is the case in conventional dryer applications. The duct may be provided with a closing means such that the duct can be closed during the benefit composition application step.

The particular benefit composition selected for use in the process can vary widely depending upon the particular benefit desired. However, in some modes of operation, the benefit composition will contain ingredients which can be effective across a variety of fabric article types. For example, the benefit composition may be suitable for “dry-clean” only fabric articles as well as pure cotton dress shirts which typically require a significant de-wrinkling operation subsequent to conventional laundering operations (i.e. home washings and drying cycles).

Non-verbal cues may also be present within the fabric article treating system to assist a user in the selection of the desired benefit composition, treatment cycle, and the like and may be present on one or more of: the device, a benefit composition container, use instructions, and other such articles associated with the fabric article treating system. While not wishing to be bound by theory, it is believed that these non-verbal cues simplify the operation of a fabric article treating system and therefore provide convenience to a user of the system. The non-verbal cues may be visual, auditory, tactile, or vibrational, signals or may comprise combinations of these signals. Non-limiting examples of non-verbal cues include: red/green lights (stop/go indicators), a window on a reservoir to indicate fluid level, icons, beeps, whistles, a rubbery grip, and the like. An example of a visual cue would be an icon of a battery that may be present on a device display as an indication to the user that the batteries need to be replaced. In another example, a tactile cue may comprise a rubbery portion of a device to indicate where a user may comfortably grip the device.

All documents cited in the Detailed Description of the Invention are, in whole or in relevant part, incorporated herein by reference. The citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for treating fabrics, said system for treating fabrics comprising:
a) a fabric article drying appliance; and
b) a fabric article treating device which is removably attachable to said fabric article drying appliance said device comprising at least one means for heating a benefit composition and comprising a dispensing apparatus for dispensing said benefit composition.

2. The system of claim 1 wherein said fabric article treating device is a discrete stand alone device.

3. The system according to claim 1 wherein said fabric article drying appliance further comprises a closure structure whereby said fabric article treating device is integral with said closure structure.

4. The system according to claim 1 wherein said benefit composition is comprised of water, solvent, surfactant, wrinkle releasing/prevention agent, anti-static agent, antimicrobial agent, wetting agent, crystal modifier, soil release/prevention agent, colorant, brightener, perfume, odor reducer/eliminator, deodorizer/refresher agent, stain repellent, color enhancer, starch, softener, sizing agent, or a combination thereof.

5. The system according to claim 1 wherein said benefit composition is heated by an exothermic reaction wherein said exothermic reaction is a metal oxidation reactions, a saturated salt reaction, an in-situ reaction, or a combination thereof.

6. The system according to claim 5 wherein the exothermic reaction has an enthalpy of −1 kJ/mole or less at 25° C.

7. The system according to claim 5 wherein said metal oxidation reaction comprises at least one metal wherein said metal is iron, copper, aluminum, magnesium, manganese, zinc, or a combination thereof.

8. The system according to claim 7 wherein the metal oxidation reaction further comprises at least one electrolyte wherein said electrolyte is an alkali metal salt, an alkaline earth metal salt, a transition metal salt, or a combination thereof.

9. The system according to claim 7 wherein the metal oxidation reaction further comprises a source of carbon wherein the source of carbon is activated, non-activated, or a combination thereof.

10. The system according to claim 5 wherein the saturated salt reaction comprises sodium acetate and water.

11. A removably attached device for attachment to a fabric article drying appliance said removably attached device comprising:
a) at least one source of a benefit composition;
b) at least one means for heating a benefit composition; and
c) a dispensing means for dispensing said benefit composition into a fabric article drying appliance.

12. The device according to claim 11 further comprising a power source wherein said power source comprises one or more batteries and wherein said batteries are disposable, rechargeable, or a combination thereof.

13 The device according to claim 11 wherein the power source is a source of household current.

14. The device according to claim 11 wherein said source of benefit composition is a reservoir, a cartridge, a pouch, or a combination thereof.

15. The device according to claim 11 wherein said dispensing means is a pump and said pump comprises:
a) a conduit wherein said conduit includes an inlet and a discharge; and
b) a nozzle connected to said discharge of said conduit;
wherein said inlet of said conduit is in communication with said source of benefit composition so as to dispense said benefit composition through said conduit from said source of benefit composition to said nozzle whereby said benefit composition is dispensed from said nozzle into said fabric article drying appliance.

16. The device according to claim 11 wherein said dispensing means comprises a source of gravitational energy, mechanical energy, potential energy, electromechanical energy or combinations thereof.

17. The device according to claim 11 wherein said means for heating said benefit composition comprises a heating coil.

18. The device according to claim 11 wherein the means for heating the benefit composition comprises a thermally conductive material within the thermal path between the fabric article drying appliance and the fabric article treating device.

19. The device according to claim 18 wherein the thermally conductive material has a thermal conductivity of at least about 5 W/m*° C. at 25° C.

20. The device according to claim 11 wherein the means for heating the benefit composition comprises a thermoelectric module.

21. A discrete stand-alone device for use with a fabric article drying appliance said discrete stand-alone device comprising:
a) at least one source of a benefit composition;
b) at least one means for heating a benefit composition; and
c) a dispensing means for dispensing said benefit composition into a fabric article drying appliance.

22. A method for treating fabrics said method comprising:
a) providing a fabric article treating device wherein said fabric article treating device comprises
i) at least one source of a benefit composition;
ii) at least one means for heating a benefit composition; and
iii) a dispensing means for dispensing said benefit composition into a fabric article drying appliance.
b) providing a fabric article drying appliance;
c) adding fabric to be treated to said fabric article drying appliance;
d) removably attaching said fabric article treating device to said fabric article drying appliance;
e) heating a benefit composition; and
f) dispensing a heated benefit composition into said fabric article drying appliance.

23. The method according to claim 22 wherein said heating step further comprises providing an exothermic composition such that said exothermic composition contacts said benefit composition whereby the temperature of the benefit composition is increased after contact with the exothermic composition.

24. The method of claim 22 further comprising providing one or more non-verbal cues to a user of the system wherein said non-verbal cues can be provided to said user wherein the user operates and/or adjusts a component of the fabric article treating system prior to step (e), during step (e), after step (e), or combinations thereof.

25. The method according to claim 22 further comprising providing instructions for use of the exothermic composition such that the benefit composition is heated.
